(19) United States
(12) Patent Application Publication
(10) Pub. No.: US 2011/0130920 A1
(43) Pub. Date: Jun. 2, 2011

(54) Method for error handling for a control device for a passenger protection system and a control device for a passenger protection system

(76) Inventors: Jochen Widmaier, Korntal-Muenchingen (DE); Markus Fislage, Leonberg (DE)

(21) Appl. No.: 12/990,968

(22) PCT Filed: Mar. 27, 2009
(86) PCT No.: PCT/EP09/53659

§ 371 Date: Jan. 31, 2011

(30) Foreign Application Priority Data
May 15, 2008 (DE) 102008001780.9

(51) Int. Cl. B60R 21/01; G06F 7/00

(52) U.S. Cl. 701/35; 701/29

(57) ABSTRACT

A method for error handling for a control device for a passenger protection system and a corresponding control device are provided, the error handling being implemented by switching off at least one function of the control device as a function of an error detection. The switching off takes place immediately after the error detection, the error qualification taking place after the switching off.

### FIELD OF THE INVENTION

The present invention relates to a method for error handling for a control device for a passenger protection system and such a control device for a passenger protection system.

### BACKGROUND INFORMATION

A method and a device for error storage in a control device of a motor vehicle is described in German Patent No. DE 40 40 927 C2. In this context, an error sequence memory is used, in which the error information is stored in the sequence in which previously labeled errors occurred. Additionally, in an error registration memory, for each error previously labeled there, the setting of an error labeling flag indicates whether the error exists at the moment, a respective error labeling flag being set if the error associated with it occurs, and the flag being reset as soon as the error no longer exists. An entry in the error sequence memory is made only if the relevant error labeling flag is not set for an error that is occurring.

### SUMMARY

A method in accordance with the present invention for error handling for a control device for a passenger protection system and a control device for a passenger protection system have the advantage that immediately after an error is detected, at least one function in the control device is switched off and an error qualification occurs after this switching-off. The result of this is that the error qualification is robust; since the function is already switched off, time is not limited, by a maximum load of a hardware module that constitutes the function, for example. The immediate switching off also allows for this function loss to become transparent without time loss, since by switching off the function after the error detection, the function is stored in a memory, for example. Because this transparency of the function restriction is provided immediately, it may be archived in snapshots, for example, by a crash recorder. Nevertheless, the error qualification in accordance with the final error cause may take place in a robust manner. According to the present invention, the switching off is performed by the error handling circuit in the control device, and a switching mechanism in the error handling circuit ensures the corresponding sequence, namely that after the error detection, the at least one function is switched off and after this switching off, the error qualification is performed.

In the case at hand, a control device is an electric device that processes sensor signals and generates control signals for the passenger protection devices as a function of them. For example, the passenger protection system may be passive restraining devices such as airbags or belt tighteners, but alternatives such as crash-active headrests and seats are also accordingly possible.

In the case at hand, the error handling is the manner in which an occurring error is handled, i.e., which measures occur when the error is detected. In this instance, at least one function of the control device is switched off as a function of the error detection and a subsequent error qualification. For example, the function of the control device may be hardware that is overloaded by the error, for example, by overheating, and may be destroyed in this manner. In this instance, the error is a short circuit to the battery voltage, for example.

In the case at hand, the error detection refers to detecting an error with the aid of a measuring value, for example, and the error qualification means that the cause of the error is determined. This may also be done using measurements or response checks. The error qualification also differs in the type of storage. A qualified error is stored permanently, so that this error is able to be read out in a workshop, for example.

In the case at hand, the immediate switching off after the error detection means that when the error detection is complete and has resulted in the detection of an error, the switching off takes place immediately afterward. A short time interval possibly exists between the end of the error detection and the switching off.

After the switching off, the error qualification occurs, so that there is sufficient time for the error qualification. That is, the time for the error qualification is no longer limited by a maximum load capacity of a function or of a hardware component.

The error handling circuit and the switching mechanism may be designed as hardware and/or software. The error handling circuit is able to switch off the at least one function of the control device as a function of the error detection and the subsequent error qualification. The switching mechanism provides the corresponding sequence, in that after the error detection, the at least one function is switched off immediately. The error qualification takes place after this switching off.

Advantageous improvements of the method for error handling for a control device for a passenger protection system and for the corresponding control device are rendered possible by the measures and further refinements described below.

It is advantageous that the error detection is implemented with the aid of at least one first error type and the error qualification with the aid of at least one second error type, the at least one first error type differing from the at least one second error type. Thus, a hierarchical difference is made clear, namely the error detection is used as the first rough instrument in order to identify errors in the first place, while the error qualification subsequently checks for critical error types. Thus, a two-stage method exists. The error detection may be implemented with the aid of a communication error as a frequently occurring error as the first error type. In contrast, the error qualification may be checked for the particularly critical error of the short circuit to the battery voltage. Of course, a plurality of error types may also be examined. The first error type is not the same as the second error type.

It is furthermore advantageous that the at least one function is switched on again as a function of the error qualification. For example, if the error qualification does not lead to the result that the function may be confirmed by the error, then the function is to be, and must be, switched on again in order to establish the complete functionality of the control device.

The error detection may be implemented in the following advantageous way:

In sequential time periods, a first counter is incremented for a respective occurrence of the at least one first error type. A first reading of this first counter is compared to a first predefined threshold value. For example, if this error type is determined in four consecutive errors and the threshold value is set to three, then the error detection is concluded upon exceeding this number, that is, upon the occurrence of the fourth error. These time periods may also be referred to as time windows.

It is furthermore advantageous if the at least one first error type is stored in a first memory in the control device immediately after the error is detected, and the at least one second error type is stored in a second memory in the control device after the successful error qualification, different access authorizations being used for the first and for the second memory, respectively. It is thus possible to achieve a situation in which an error is not stored in a memory accessible in the workshop unless it is also actually qualified. The first memory is provided for a deep analysis at the manufacturer of the control device, in order to evaluate the information that was stored with the first error type. That is, the access authorizations allow or do not allow different users to read the memory content.

The error detection is advantageously temporally shorter than the error qualification. This means, for example, when the error detection detects an error in four consecutive time periods, and these four time periods are then shorter in total than required by the error qualification for its qualification of the error. Thus, the error qualification becomes very robust since the time period, which is provided in a plurality of 100 ms, for example, is sufficient to robustly qualify an error.

Furthermore, it is advantageous if a second counter is incremented or decremented as a function of the error qualification, and that a second reading of the second counter is compared to a second threshold value to ensure the storage in the second memory. In this context, for example, the counter for the error qualification is incremented only if a specific error type occurs, whereas when another error type occurs, or when no error occurs in a specific time period, decrementing results. This counter reading is also compared to a threshold value and the error qualification is then stored as a function thereof.

It is advantageous if the second counter is incremented only if the error qualification is followed by a switching off. That is, if a short circuit to battery voltage is qualified, then the switching off is unavoidable and the counter is incremented only in this instance.

### BRIEF DESCRIPTION OF THE DRAWINGS

Exemplary embodiments of the present invention are illustrated in the figures and are explained in greater detail below.

FIG. 1 shows a block diagram of the control device according to the present invention having connected components.

FIG. 2 shows a first flow chart.

FIG. 3 shows a time sequence chart.

FIG. 4 shows a second flow chart of the method according to the present invention.

### DETAILED DESCRIPTION OF EXAMPLE EMBODIMENTS

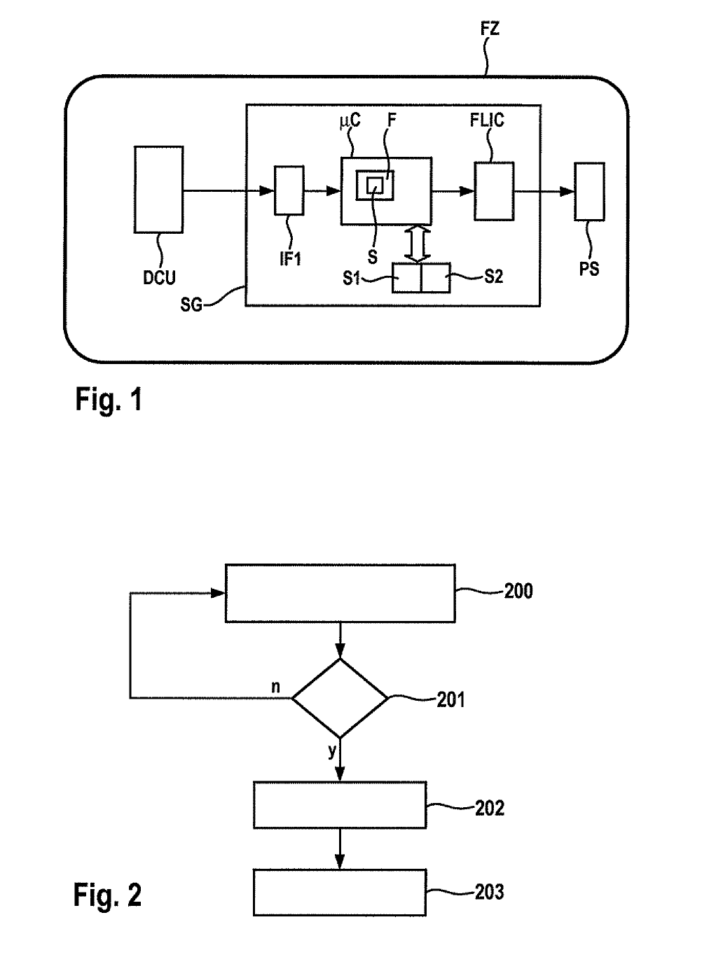

FIG. 1 shows in a block diagram control device SG in accordance with the present invention having connected components DCU and PS in a vehicle FZ. A sensor control device DCU transmits sensor signals digitally via a two-wire line to control device SG. Sensor control device DCU houses a plurality of sensors that provide accident-relevant signals. Such sensors are acceleration sensors in different spatial directions, rotary motion sensors, structure-borne noise sensors, or other conventional sensors.

These signals from sensor control device DCU are received by an interface IF1 in control device SG. In the case at hand, the interface is designed as an integrated circuit and at least reformats the sensor signals into a transmission format that is used inside of control device SG, for example, that of the SPS (serial peripheral interface) bus. The sensor signals are accordingly transmitted from interface IF1, which alternatively may also be part of a so-called system ASIC, to a microcontroller μC in control device SG. Microcontroller μC evaluates the sensor signals to see whether passenger protection devices PS are to be triggered or not. According to the present invention, a program for error handling runs on microcontroller μC at the same time. This program F, which makes up the error handling circuit in the case at hand, provides the error detection, provides the switching off of at least one function in control device SG as a function of the error detection, and also provides for the subsequent error qualification. Two memories S1 and S2, with which microcontroller μC is connected via a data input/output, are provided for error storage.. Memories S1 and S2 are physically separated in the case at hand; however, they may also be implemented in the same memory, since the memories S1 and S2 differ only in terms of their access authorizations for the data that are stored in memories S1 and S2. Such a memory S1 and S2 may be an EE-PROM, for example. Memory Si is provided with a higher access authorization than memory S2, which may be read out in the workshop, for example, in order to analyze errors determined by control device SG. For example, memory S1 may be read out only at the manufacturer of control device SG, in order to implement a deeper analysis.

Microcontroller μC possibly transmits a triggering signal to triggering circuit FLIC, which may likewise be part of the system ASIC. Triggering circuit FLIC has power switches that are electrically controllable. The power switches are closed when passenger protection devices are to be triggered in order to supply current to these passenger protection devices.

In the case at hand, only the components for gaining an understanding of the present invention are shown. Other components used for operating control device SG but not contributing to an understanding of the present invention have been omitted for the sake of simplicity. Conventional alternatives are possible with regard to the individual components. For example, sensors may be provided in control device SG itself.

FIG. 2 shows an example method according to the present invention in a flow chart. In method step 200, the error detection is carried out. In method step 201, a check is performed to see whether an error was detected or not. If this is not the case, then method step 200 is repeated. However, if an error was detected then at least one function of control device SG is switched off immediately in method step 202. The error qualification takes place in method step 203.

Both the error detection results and the error qualification results respectively may be stored, with different access authorizations, however. By switching off the function immediately after the error detection, the function loss becomes transparent to the whole system through the switching off. The storing of the error detection may take place in an event recorder or crash recorder, for example.

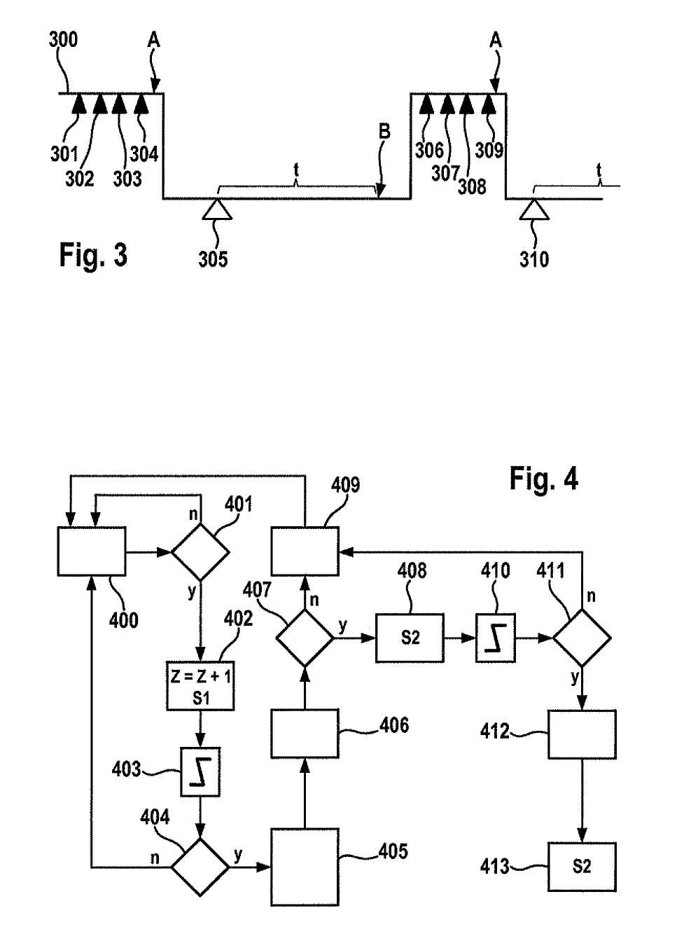

FIG. 3 illustrates error detection and error qualification according to the present invention in a time sequence diagram. The error detection and error qualification are performed with the aid of a sensor signal 300. The error detection takes place in time periods 301 to 304, in that a check is performed for a communication error. A communication error may be determined through a check sum, a parity bit, or with the aid of signal levels, for example. In general, voltage drops, tolerances, or other disruptions are the reason why a correct signal does not enter the reading hardware. In the case at hand, the check for communication errors takes place in four consecutive time periods 301 to 304, because the error detection has actually detected an error only if the communication error is determined in each time period. Then the relevant function, for example, a receiving module, is switched off at time A. Error qualification 305 then takes place in the switched-off state.

In the error qualification, a check is performed for an additional error type, to wit, a short circuit. If a short circuit is detected, then the communication error is disqualified. Time t, for example, one second or several hundred milliseconds, is available for the error qualification. For example, this may be achieved through measurements. At time B, this error qualification is concluded, and if only a short circuit to ground is detected, the function is switched on again. The function is likewise switched on again in the event of a communication error. The function remains switched off only in the event of a short circuit to battery, since then the corresponding function or a hardware module in control device SG may be overloaded. In time windows 306 to 309, a communication error is again determined in order to then, in turn, switch off the function at time A. Error qualification 310 takes place like qualification 305.

The error detection indexes a problem and the switching off is thus initiated. An error counter is incremented only when a switching off is implemented. Thus, the function loss after the switching off of the function is made transparent to the system, but the error is not yet stored. This typically takes place only when the counter exceeds an adjustable threshold. In order to ensure that the indexing error does not reach error qualification, the error counter is decremented even when a deviating first error cause is detected. This does not result in a loss in transparency. The indexing error thus indeed exists in an error memory (system transparency), but is not yet stored in the error memory, since it is not yet qualified. A possible event recorder may also store via the error memory as well, in that the indexing error exists, but is not yet labeled as qualified. The final error cause may then be configured via a plurality of switch-on/switch-off cycles of the relevant periphery.

FIG. 4 shows the method according to the present invention in accordance with a special design in another block diagram. The check for the communication errors takes place in method step 400. In method step 401, a check is performed to see whether a communication error exists or not. If this is not the case, then a return to method step 400 takes place. However, if this is the case, then the system proceeds to method step 402. In this instance, a counter Z, which was previously set to zero, is incremented. In the same manner, the current data may be stored in a memory that is to be accessible later only for the manufacturer of the control device. The incremented counter reading is subjected to a threshold value check in method step 403. In method step 404, the outcome of the threshold value comparison is checked. If counter reading Z is below the threshold value, then a return to method step 400 takes place. However, if it is above the predefined threshold, then the switching off is performed in method step 405. The error qualification according to the second error type occurs in method step 406. In method step 407, a check is performed to see whether the qualification for the second error type was successful or not. If this is not the case, then in method step 409, the function is switched on again and a return to method step 400 is implemented.

However, if it was determined in method step 407 that the second error type, to wit, the short circuit to battery, for example, was qualified, then in method step 408, an additional counter C is incremented and accordingly stored in error memory S2.

The counter reading of counter C is subjected to a threshold value comparison in method step 410. In method step 411, a check is carried out to see whether the counter reading has exceeded the additional threshold value or not. If this is not the case, then a return is made to method step 409. However, if this is the case, then the system proceeds to method step 412, where the error handling is implemented, that is, the switching off, for example. The storing in error memory S2 takes place in method step 413.

1-10. (canceled)

11. A method for error handling for a control device for a passenger protection system, comprising:
switching off at least one function of the control device as a function of an error detection, wherein the at least one function is switched off immediately after the error detection; and
qualifying the error after the switching off.

12. The method as recited in claim 11, wherein the error detection is implemented with the aid of a first error type and the error qualification with the aid of at least one second error type, the at least one first error type differing from the at least one second error type.

13. The method as recited in claim 11, wherein the at least one function is switched on again as a function of the error qualification.

14. The method as recited in claim 12, wherein the at least one first error type is a communication error and the at least one second error type is a short circuit.

15. The method as recited in claim 12, wherein the error detection is implemented by incrementing a first counter for a respective occurrence of the at least one first error type in consecutive time periods, and comparing a first reading of the first counter to a first predefined threshold value.

16. The method as recited in claim 12, wherein the at least one first error type is stored in a first memory in the control device immediately after the error is detected, and the at least one second error type is stored in a second memory in the control device after successful error qualification, different access authorizations being used for the first and for the second memory, respectively.

17. The method as recited in claim 11, wherein the error detection is temporally shorter than the error qualification.

18. The method as recited in claim 15, wherein a second counter is incremented or decremented as a function of the error qualification, and a second reading of the second counter is compared to a second predefined threshold value, the error qualification being stored in the second memory as a function of the threshold value comparison.

19. The method as recited in claim 18, wherein the second counter is incremented only if the error qualification is followed by a switching off of the at least one function.

20. A control device for a passenger protection system, comprising:
an error handling circuit for switching off at least one function of the control device as a function of an error detection, the error handling circuit including a switching mechanism for the immediate switching off of the at least one function after the error detection and for performing an error qualification after the switching off.
